(19) United States
(12) Patent Application Publication
(10) Pub. No.: US 2026/0334637 A1
(43) Pub. Date: Oct. 29, 2026

(54) Belt buckle

(71) Applicant: Jeff Mcwhinney, Mill valley, CA (US)

(72) Inventor: Jeff Mcwhinney, Mill valley, CA (US)

(21) Appl. No.: 19/192,047

(22) Filed: Apr. 28, 2025

(51) Int. Cl. A44B 11/00; A44B 11/25; A44B 11/26; F21V 21/096; F21V 23/04

(52) U.S. Cl. CPC A44B 11/005; A44B 11/2592; A44B 11/266; F21V 21/0965; F21V 23/0414

(57) ABSTRACT

The Improved Belt Buckle provides an aftermarket modular belt system comprising a low-profile, quick-release buckle with enhanced functionality. The buckle includes an integrated, detachable flashlight module operable during normal wear, secured via magnetic and nesting attachment features for tool-free interchangeability. Additional modular features include interchangeable faceplates, a belt pinch system for slim profile adjustment, and accessory modules. The buckle may be offered as part of a kit containing alternative flashlight inserts and specialized tools to facilitate retrofitting existing belts, thereby elevating belt utility, aesthetics, and versatility.

### BACKGROUND OF THE INVENTION

Companies like Arcade Belts have advanced the field of specialty belts by utilizing lightweight materials, elastic webbing, and low-profile quick-release plastic buckles. These belts cater to active lifestyles and offer comfort, ease of use, and visual appeal at accessible price points. However, plastic buckles limit customization, durability, and functionality, and may lack the aesthetic refinement expected in more formal or fashion-forward environments. By replacing plastic components with precision-machined metal, belts can achieve both improved performance and an elevated, premium appearance, making them suitable for a wider range of activities and social settings. There exists a need for an aftermarket solution offering enhanced modularity, functionality, and long-term user value.

### SUMMARY OF THE INVENTION

The Improved Belt Buckle advances belt technology by offering an aftermarket solution that provides seamless interchangeability with existing plastic buckle belts. This improved design features smoother activation, added functionality, and the ability to swap out faces for customizable aesthetics. By incorporating these upgrades, the Improved Belt Buckle aims to elevate the user experience and meet the evolving demands of modern consumers seeking convenience, versatility, and style in their belt accessories.

Notably, the invention includes a modular flashlight system that integrates into the buckle and can be detached via a magnetic and nesting interface, offering users hands-free lighting while worn and the ability to swap between modules (e.g., white and red LEDs). Additional improvements include a low-profile, spring-loaded quick release, integrated belt pinch adjustment, and an ecosystem of accessories that can be packaged as a complete buckle system.

### BRIEF DESCRIPTION OF THE DRAWINGS

FIG. 1 is a perspective view of the Improved Belt Buckle in the closed, engaged position.

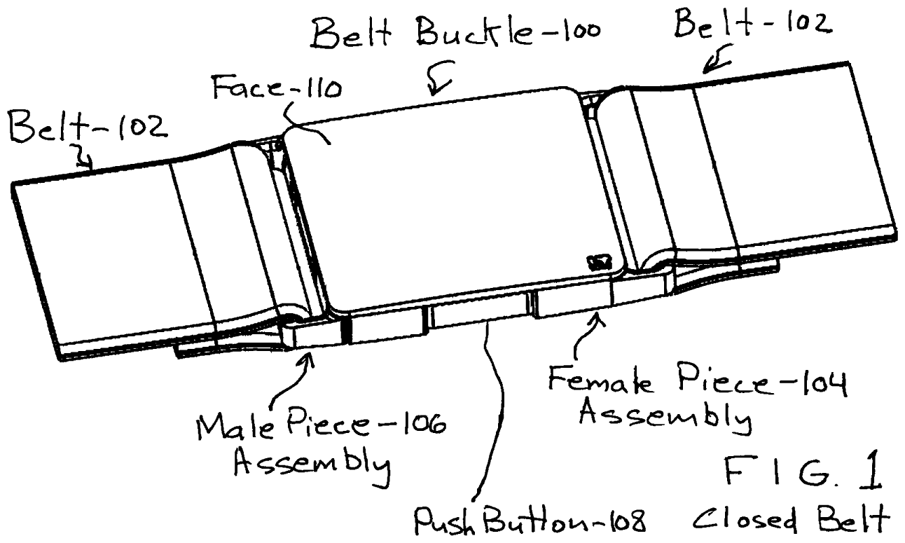

FIG. 2 is a perspective view of the Improved Belt Buckle in the open, disengaged position.

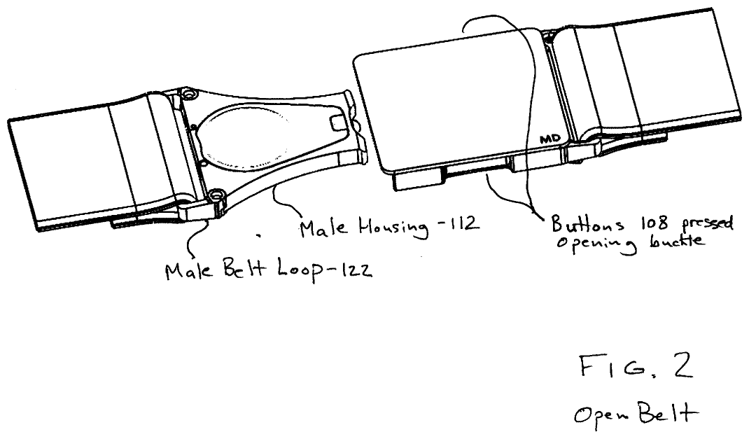

FIG. 3 is a top exploded view of the Improved Belt Buckle showing internal component arrangement.

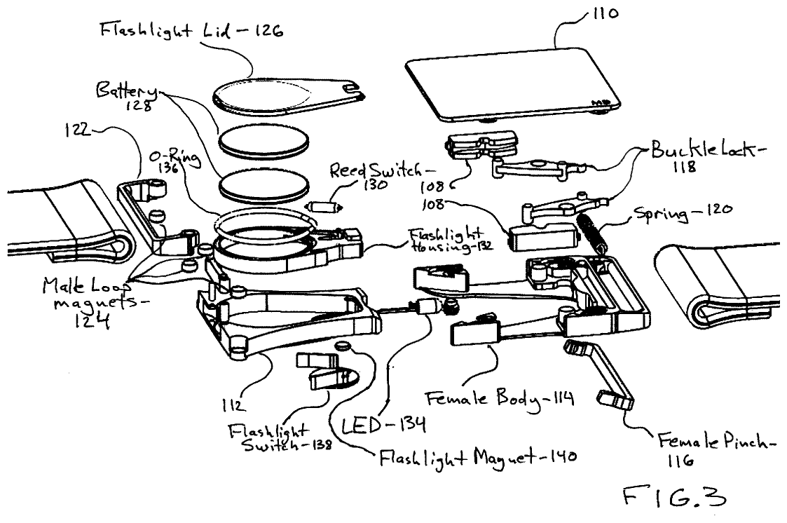

FIG. 4 is a bottom exploded view of the improved belt buckle showing internal component arrangement.

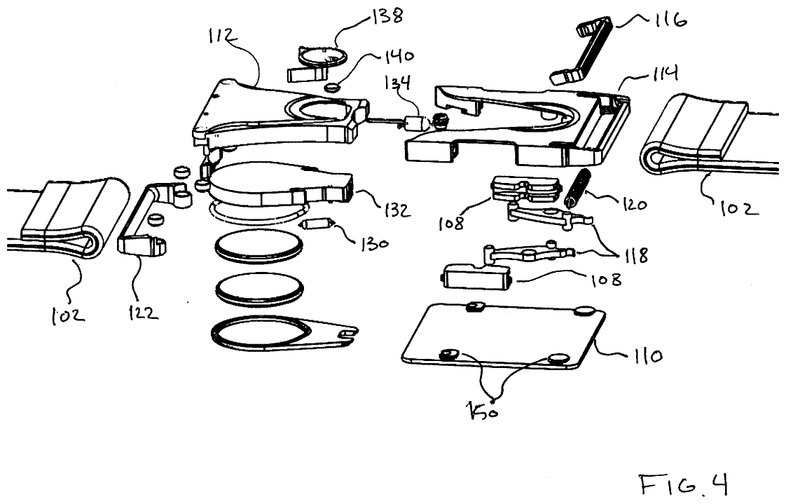

FIG. 5 is a perspective view of the male belt loop detached from the male housing.

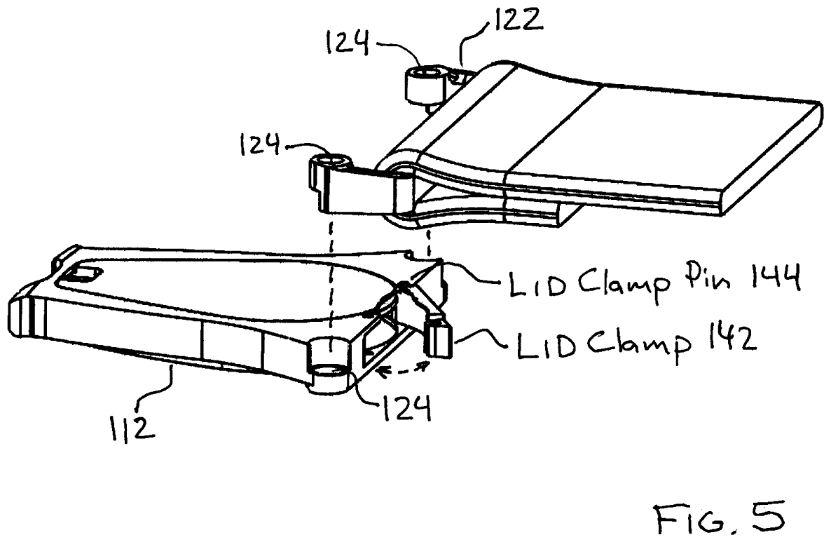

FIG. 6 is a perspective view of the male housing containing the integrated flashlight module.

FIG. 7 is a rear view of the buckle assembly with the flashlight off and belt pinch mechanism closed.

FIG. 8 is a rear view of the buckle assembly with the flashlight on and belt pinch mechanism open.

FIG. 9 is an internal exploded view of the buckle showing the locking mechanism in a locked state.

FIG. 10 is an internal exploded view of the buckle showing the locking mechanism in an unlocked state.

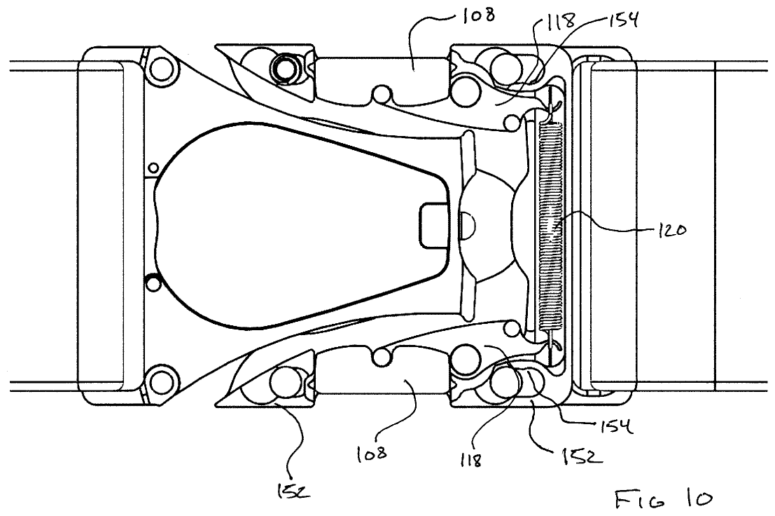

FIG. 11 is an isometric view of the packaging system containing the buckle and modular accessories.

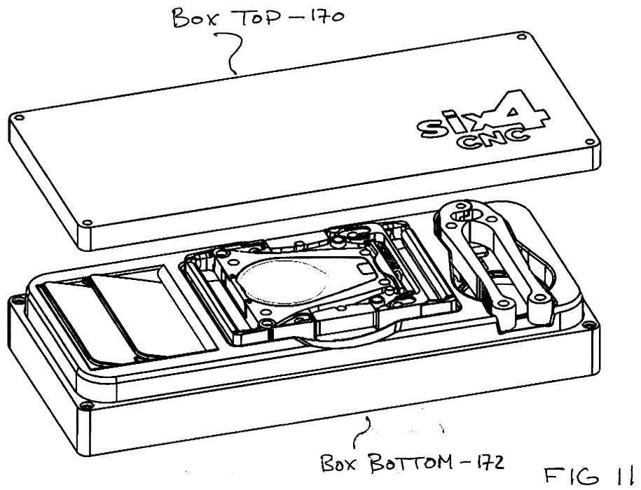

FIG. 12 is an exploded view of the packaging system components, including the buckle, faceplates, flashlight module, and clippers.

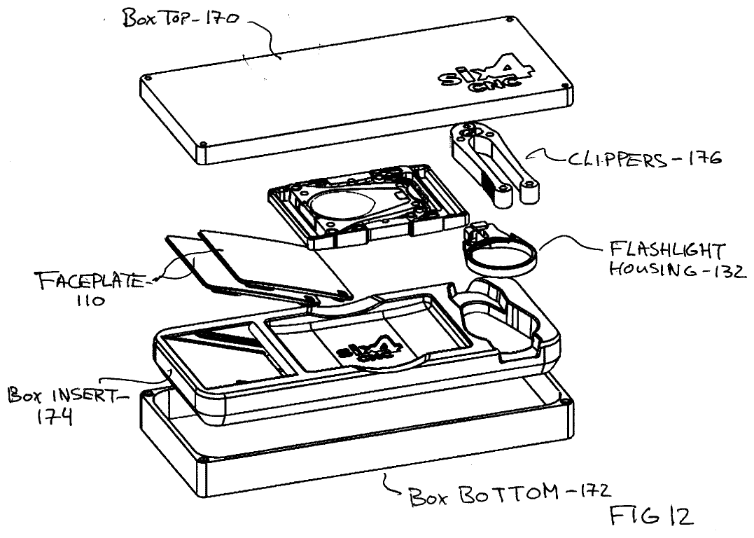

### DETAILED DESCRIPTION OF THE INVENTION

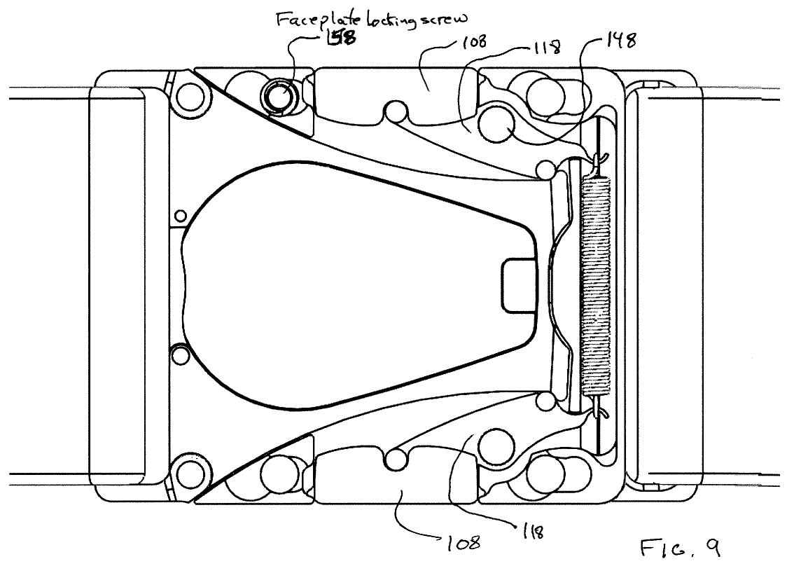

The Improved Belt Buckle includes a low-friction parallel push quick-release activation system. As shown in FIG. 9, spring 120 provides tension for locking components 118 and push buttons 108, holding the male 106 and female 104 assemblies in the locked position. Pressing both buttons inward pivots the lock components 118 around axis 148 to release the male component.

The buckle allows faceplates 110 to be swapped via a spring-tensioned post 150 and pocket 152 interface. Additional retention is optionally provided by set screws 158. Dovetail attachments may alternatively be used.

A belt pinch 116 located within female body 114 allows tool-free adjustment while still requiring the belt 102 to loop back on itself, but without passing through a bulky loop-back maze, thereby reducing thickness and preserving a low profile. A ramped slot 160 guides the pinch component, which locks under belt tension as it pivots into a nested pocket.

The male belt loop 122 can be removed from the male housing 112, enabling belt changes without cutting or sewing. Magnetic elements 124 in components 122 and 112 provide tool-free, secure reattachment through mating magnetic surfaces and nested pockets.

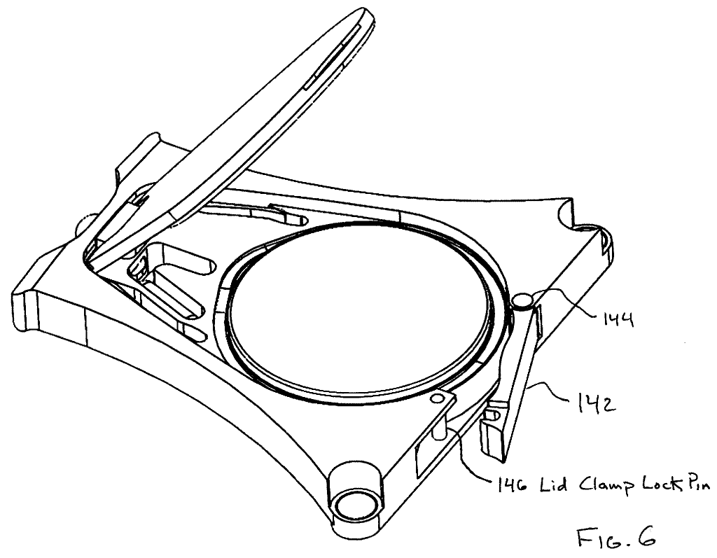

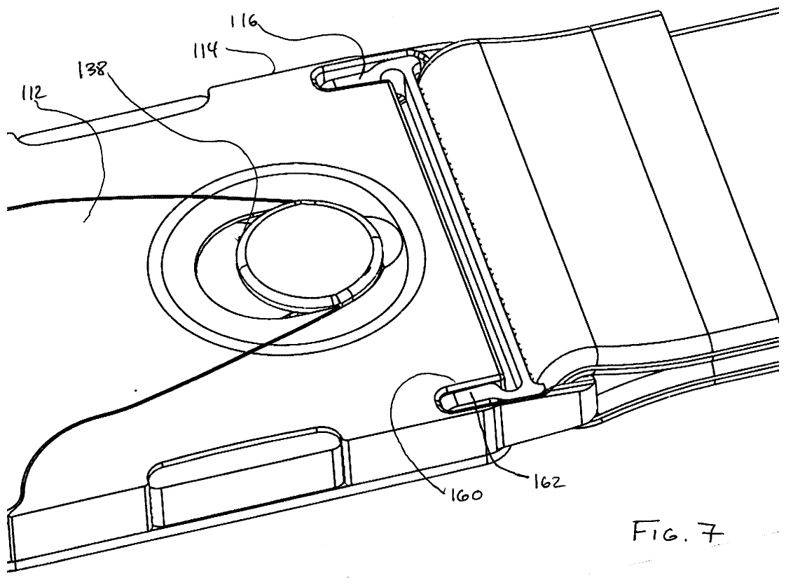

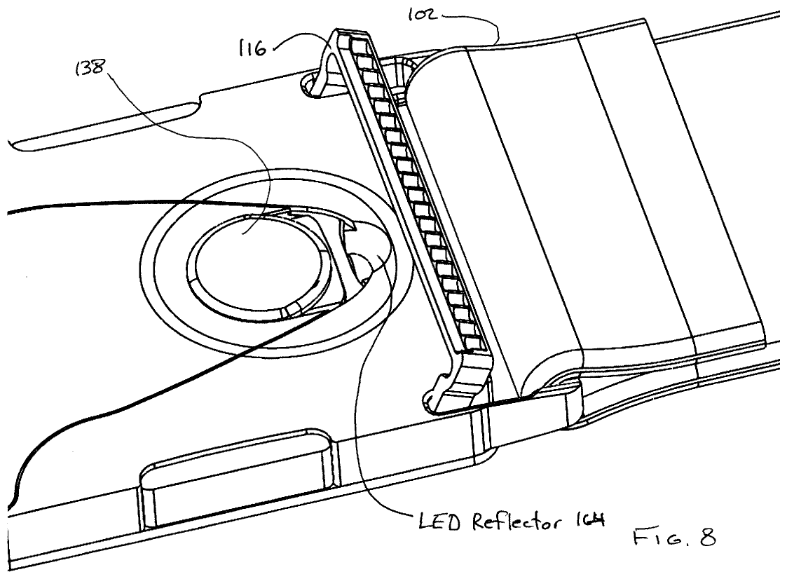

The flashlight assembly, detailed in FIGS. 6, 7, and 8, includes parts 126 through 140. It can be operated while the buckle is worn and oriented by twisting the belt to direct light downward or outward. A reed switch 130 is one preferred actuation method for sealing the module against water ingress, though other waterproof switches may be used. Optional reflectors 164 can enhance directional lighting. Modular accessory inserts may alternatively include storage, blades, writing tools, or emergency survival elements.

In some embodiments, the Improved Belt Buckle may be packaged as part of a modular system including box top 170 and box bottom 172, with insert 174 securing the buckle assembly, interchangeable faceplates 110, an alternative flashlight module 132 (e.g., red LED), and clippers 176 for removing existing belt buckles. This system enhances modularity, user convenience, and supports aftermarket adoption.

1. A belt buckle assembly comprising:
a buckle body having a male portion and a female portion configured to releasably engage with each other;
an accessory module integrated into the buckle body, the accessory module including a flashlight assembly operable to emit light while the belt buckle assembly is worn;
a modular attachment interface configured to removably couple the accessory module to the buckle body, the attachment interface comprising at least one of:
magnetic elements providing tool-free retention, and/or
complementary mating features including nested pockets, projections, or keyways to maintain positional stability during attachment and detachment;
wherein the modular attachment interface enables reversible, tool-free separation and reattachment of the accessory module from the buckle body.

2. The belt buckle assembly of claim 1, wherein the flashlight assembly comprises:
a sealed housing containing a light source, a power supply, and a switching mechanism configured to actuate the light source, optionally including a reed switch or other water-resistant activation means.

3. The belt buckle assembly of claim 1, wherein the flashlight assembly is positioned on an underside of the buckle body such that light is directed toward the wearer during normal use, and wherein the orientation of the flashlight assembly can be altered by twisting the belt, thereby rotating the buckle relative to the wearer's body.

4. The belt buckle assembly of claim 3, wherein twisting the belt repositions the buckle to direct emitted light downward, outward, or toward a desired area surrounding the wearer.

5. The belt buckle assembly of claim 1, wherein the accessory module further comprises a clamp mechanism to secure a cover over the power supply of the flashlight assembly.

6. The belt buckle assembly of claim 1, wherein the male portion includes a quick-release push button mechanism configured to disengage the male and female portions upon application of opposing lateral forces.

7. The belt buckle assembly of claim 1, wherein the female portion includes an integrated belt pinch mechanism configured to secure and adjust a belt with a loop-back path that avoids a traditional multi-pass maze structure, thereby maintaining a low overall profile and minimizing the thickness of the assembled belt and buckle.

8. The belt buckle assembly of claim 1, wherein the modular attachment interface utilizes both magnetic elements and mechanical nesting features to enhance retention stability.

9. The belt buckle assembly of claim 1, wherein the accessory module is configured to alternatively house one or more of:
a small storage container,
a magnifying lens,
a blade or cutting tool,
a writing implement,
a memory card, or
an emergency ignition source.

10. The belt buckle assembly of claim 1, wherein a faceplate of the buckle body is removably attached via spring fingers engaging a post and pocket structure, enabling customizable decorative or functional faceplate options.

11. The belt buckle assembly of claim 1, wherein the flashlight assembly is configured to provide hands-free illumination to enhance user safety in low-light environments.

12. The belt buckle assembly of claim 1, wherein the assembly is provided as part of a kit including:
at least one additional interchangeable faceplate,
at least one alternative flashlight module, and
a specialized tool configured to assist in removing a pre-existing belt buckle from a belt strap.
